(19) United States
(12) Patent Application Publication
(10) Pub. No.: US 2020/0167860 A1
(43) Pub. Date: May 28, 2020

(54) Automated Anti-Money Laundering Compliance SaaS

(71) Applicant: Maria E. Lau, Campbell, CA (US)

(72) Inventor: Maria E. Lau, Campbell, CA (US)

(21) Appl. No.: 16/198,771

(22) Filed: Nov. 22, 2018

(51) Int. Cl. G06Q 40/02; H04L 9/06

(52) U.S. Cl. CPC G06Q 40/025; H04L 2209/38; H04L 9/0637

(57) ABSTRACT

FISE Portal is an automated software as a service anti-money laundering (AML), know your customer (KYC) platform. It assists and incentivizes financial institutions to complete time and labor intensive AML/KYC due diligence, mandated by section 326 of the USA PATRIOT ACT, a counter-terrorist law enacted after 9/11. The platform is applicable to all financial institutions and money services businesses in the United States and globally, wherever anti-money laundering compliance laws are enforced.

### REFERENCES CITED

McLannahan, Ben. “US banks ‘wasting billions’ trying to track crime.” Financial Times, Feb. 16, 2017. https://www.ft.com/content/4af5c5b8-f473-11e6-8758-6876151821a6
Finch, Gavin. “World's Biggest Banks Fined 321 Billion Since Financial Crisis.” Bloomberg, Mar. 1, 2017. https://www.bloomberg.com/news/articles/2017-03-02/world-s-biggest-banks-fined-321-billion-since-financial-crisis
Chatterjee, Sumeet. “US, EU fines on banks' misconduct to top $400 billion by 2020: report.” Reuters, Sep. 27, 2017. https://www.reuters.com/article/us-banks-regulator-fines/u-s-eu-fines-on-banks-misconduct-to-top-400-billion-by-2020-report-id USKCN 1C210B United Nations Office on Drug and Crime. “Money Laundering and Globalization.” https://www.unodc.org/unodc/en/money-laundering/globalization.html
International Monetary Fund. “IMF and the Fight Against Money Laundering and the Financing of Terrorism.” Mar. 8, 2018. https://www.imf.org/en/About/Factsheets/Sheets/2016/08/01/16/31/Fight-Against-Money-Laundering-the-Financing-of-Terrorism
Mitek Systems. “Typical UK bank will waste £10 m annually on inefficient KYC checks as AMLD4 regulation comes into force.” https://globenewswire.com/news-release/2017/06/26/1028793/0/en/Typical-U K-bank-will-waste-10m-annually-on-inefficient-KYC-checks-as-AMLD4-regulation-comes-into-force.html
Culp, Steve. “Banks Need New Approaches In Complying With Financial Crimes Regulations.” Forbes, Mar. 5, 2018. https://www.forbes.com/sites/steveculp/2018/03/05/banks-need-new-approaches-in-complying-with-financial-crimes-regulations/#5ddf107c4147
Financial Crimes Enforcement Network. “USA PATRIOT Act.” https://www.fincen.gov/resources/statutes-regulations/usa-patriot-act
Treanor, Jill. “JP Morgan Chase hires 3,000 new staff in its compliance department.” The Guardian, Sep. 17, 2013. https://www.theguardian.com/business/2013/sep/17/jpmorgan-banking
Thomson Reuters. “Thomson Reuters 2017 Global KYC Surveys Attest to Even Greater Compliance Pain Points.” Thomson Reuters, Oct. 26, 2017. https://www.thomsonreuters.com/en/press-releases/2017/october/thomson-reuters-2017-global-kyc-surveys-attest-to-even-greater-compliance-pain-points.html
Nividous. “Robotic Process Automation (RPA) is set to transform risk and regulatory compliance in banking and financial services.” Nividous, May 23, 2018. http://nividous.com/nividous-comrpa-transform-risk-regulatory-compliance-in-banking-financial-services/
Friesen, Connie. US and UK Anti-Money Laundering Requirements Compared. Sidley International Law Office, Sep. 5, 2008. https://www.internationallawoffice.com/Directory/Sidley-Austin-LLP/New-York-NY/Connie-M-Friesen
Protiviti. “Remediate Risk, Not Files. Breaking the KYC Remediation Cycle.” https://www.protiviti.com/sites/default/files/remediate-risk-_not-files-breaking-the-kyc-remediation-cycle-protiviti_1.document
Khosla, Reetu. “Why KYC Regulations, Client Onboarding and Digital Transformation Are Driving Banks To Invest In Technology.” International Banker, Jun. 28, 2016. https://internationaIbanker.com/technology/kyc-regulations-client-onboarding-digital-transformation-driving-banks-invest-technology/
Hodge, Ryan. “Informal Value Transfer Systems: A Financial Institution's Perspective.” ACAMS, September 2013. http://www.acams.org/wp-content/uploads/2015/08/Informal-Value-Transfer-Systems-A-F-s-Perspective-Ryan-Hodge.document
Owyang, Jeremiah. “Graphic: Blockchain for Every Industry.” NewCo Shift, Jul. 11, 2017. https://shift.newco.co/graphic-blockchain-for-every-industry-dfcbdcfe23ea
Burgin, Paul and Aviva Freudmann, eds. “From Concept to Reality: How Blockchain Will Reshape the Financial Services Industry.” UK Department for International Trade and The Economist Intelligence Unit, 2018. https://perspectives.eiu.com/sites/default/files/CCS150_CCS1117370718-1_Blockchain %20Brochure.document
Kehoe, Lory, Eric Piscini, Paul Sin, and Eoin Connolly. “Six Control Principles for Financial Services Blockchains.” Deloitte, 2017. https://www2.deloitte.com/content/dam/Deloitte/cn/Documents/financial-services/deloitte-cn-fs-six-principles-for-blockchains-report-en-171121.document

### TECHNICAL FIELD

The use of blockchain and automation in Know Your Customer (KYC) compliance processes.

### BACKGROUND

In the last two decades, innovations in technology and finance have increased the pace and ease with which transactions are performed around the globe. While advanced technologies have improved business operations, financial crimes under the money laundering umbrella have also taken advantage of the improved technology, creating unmanageable AML workloads, expenses, corporate disorientation, and exacerbation of inefficient compliance processes.

For better or for worse, the embarrassments continue, leaving a regulatory technology void within the anti-money laundering (AML) Know Your Customer (KYC) administrative sector. Between 2008 and 2017, the world's biggest banks were fined $321 billion for failing to meet AML KYC regulatory standards. Due to rising compliance costs, existing administrative inefficiencies, and a projected $400 billion in AML banking fines by 2020, FISE Portal's KYC platform aims to relieve compliance costs whilst supporting financial institutions in meeting or exceeding AML KYC regulatory standards.

According to research, global money laundering accounts for 2-5% of the global GDP or approximately $1-2 trillion annually. The International Monetary Fund (IMF) defines money laundering as the processing or “cleaning” of funds from criminal activity to conceal the link between the funds and their illegal origins.

As of 2017, major international banks are spending $900 million to $1.3 billion annually on AML compliance. Each year as costs and economic inflation rise, AML costs will increase commensurately, unless a more efficient, automated technological solution is created.

### BRIEF DESCRIPTION OF THE DRAWINGS

FIG. 1 shows a new subscription to the portal.

FIG. 2 shows a customer applying for a new bank account and the banker interacting with the portal to start KYC.

FIG. 2a shows the customer uploading identification data and documents. FIG. 2b shows the portal calculating an initial risk score by confirming the identification data with independent databases.

FIG. 3 shows the analyst initializing automated due diligence after being notified of the risk score.

FIG. 3a shows the portal recalculating the risk score by conducting due diligence through news and compliance lists.

FIG. 4 shows the analyst interacting with the news, compliance list results, and summary.

FIG. 5 shows portal ledger making records of KYC and incentives.

FIG. 6 shows the fulfillment of smart contracts per user on the blockchain and corresponding payments.

### DETAILED DESCRIPTION OF THE PREFERRED EMBODIMENT

What we claim as new and desire to secure by letters patent is set forth in the following claims.

We define some terminology.

This submission is a software as a service (SaaS) portal that automates and incentivizes compliance processes. Per section 326 of the USA PATRIOT Act, financial institutions are required to execute the following: (https://www.ffiec.gov/bsa_aml_infobase/pages_manual/OLM_011.htm).
1. Gather customer identification data including name, date of birth, address, and identification number (social security number).
2. Verify the accuracy of customer identification data to support a reasonable belief about the customer's true identity.
3. Describe compliance methods in policies and procedures.
4. Gather and verify documents such as unexpired government issued photo ID and utility bill which states customer's physical address, and any entity incorporation documents.
5. Independently verify customer identification using comparisons to information provided by consumer reporting agencies, public databases, and checking references from other financial institutions.
6. Keep records and retain requirements of all customer identification data and CIP activity logs.
7. Compare customers to federal government lists regarding terrorists or terrorist organizations.
8. Provide notice to the customer concerning identification requirements related to AML policies and procedures.

Furthermore, best practices include creating risk profiles for customers and scheduling ongoing KYC due diligence checks accordingly.

This submission is about automating each of the above actions as well as providing incentives to motivate the completion of Section 326's Customer Identification Program (CIP) and related KYC tasks.

The Background described the increasing costs associated with current compliance processes due to lack of adequate technological developments. The current submission wishes to fulfill and develop technological solutions to remedy the increasing costs and time intensive processes of AML compliance.

The submission has the following sections:
1. Initial Subscription
2. New Customer Application
3. Gathering Customer Data and Documents
4. Automated KYC Processing
5. Notification and Automated Due Diligence
6. Summary and KYC Completion
7. Portal Ledger Metrics
8. Incentivization

### 1. Initial Subscription

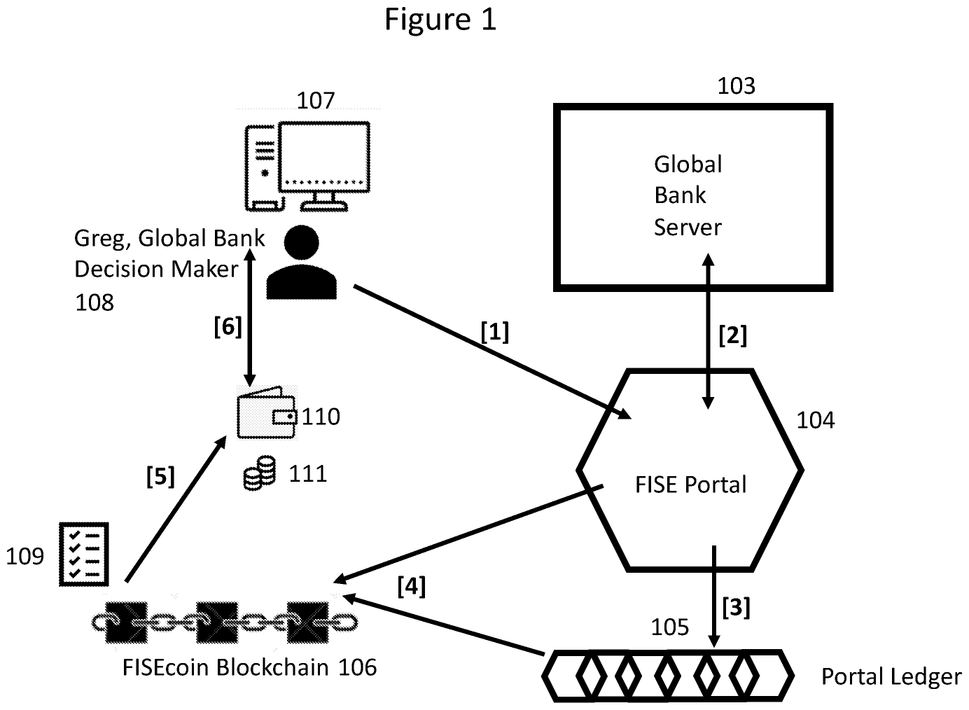

See FIG. 1.

It shows a user Greg 108, who is a decision maker at Global Bank, using his computer 107, to connect to FISE Portal 104. This is designated with the arrow [1]. Greg completes a subscription application to FISE Portal 104.

FISE Portal approves the subscription and connects to Global Bank Server 103, as shown by arrow [2]. FISE Portal creates a new user account for Global Bank on Portal Ledger 105, as designated by arrow [3]. Portal Ledger accommodates multiple user accounts, each associated with a separate institutional subscriber. The Portal Ledger is not in a blockchain format. It can be stored in several data centers in conventional methods that do not use blockchain. The Portal Ledger should not be confused with the internal ledger of the blockchain. The blockchain and the ledger may be separate or combined with FISE Portal, the server.

FISE Portal confirms the new subscription, and Portal Ledger confirms the new private ledger with FISEcoin Blockchain 106, designated by arrows [4]. The smart contract 109 is triggered and fulfilled, allowing FISEcoin Blockchain to create a wallet 110 and send FISEcoin tokens 111 to the wallet.

The Portal Ledger holds the original digital documents whereas the FISEcoin Blockchain 106 stores the hashes of the data, which hold the documents. This minimizes the amount of storage in the nodes of the blockchain.

The wallet and FISEcoin become property of Global Bank, and Global Bank's decision makers may save, transfer, trade or cash out the FISEcoin tokens. FISEcoin tokens are tethered to the Swiss Franc with a dividend or interest rate return of 1.75%, for example, as they are considered a security. Global Bank is now a participant of the token economy and may also create investment vehicles and products for FISEcoin tokens.

### 2. New Customer Application

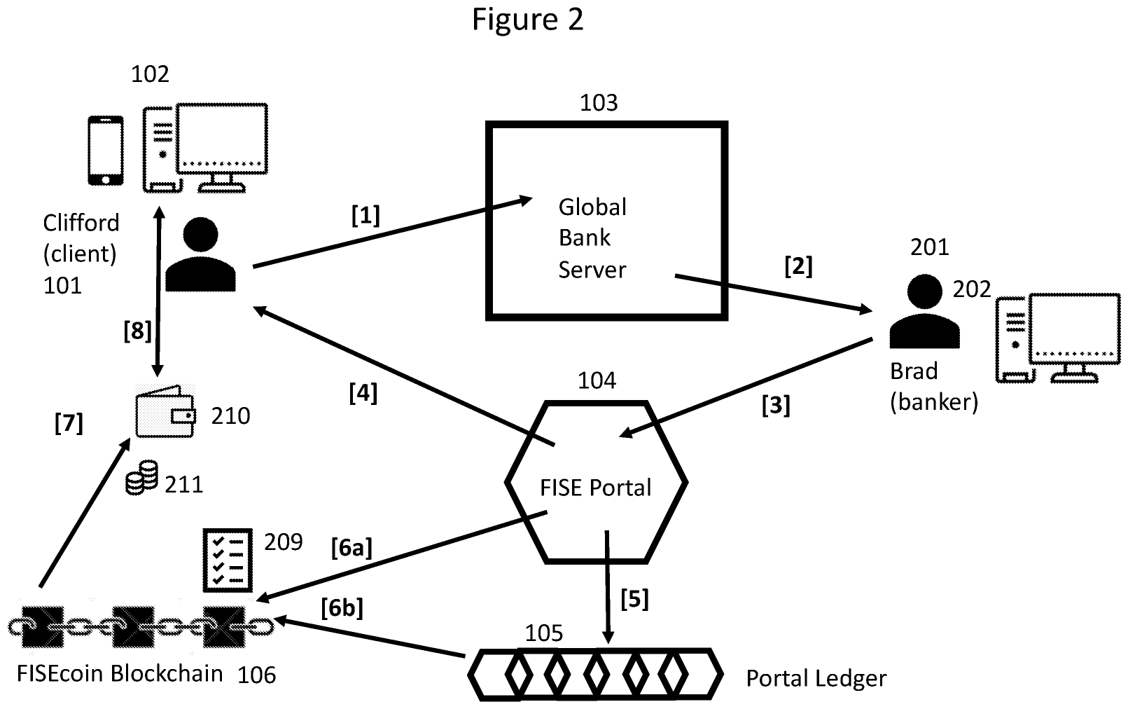

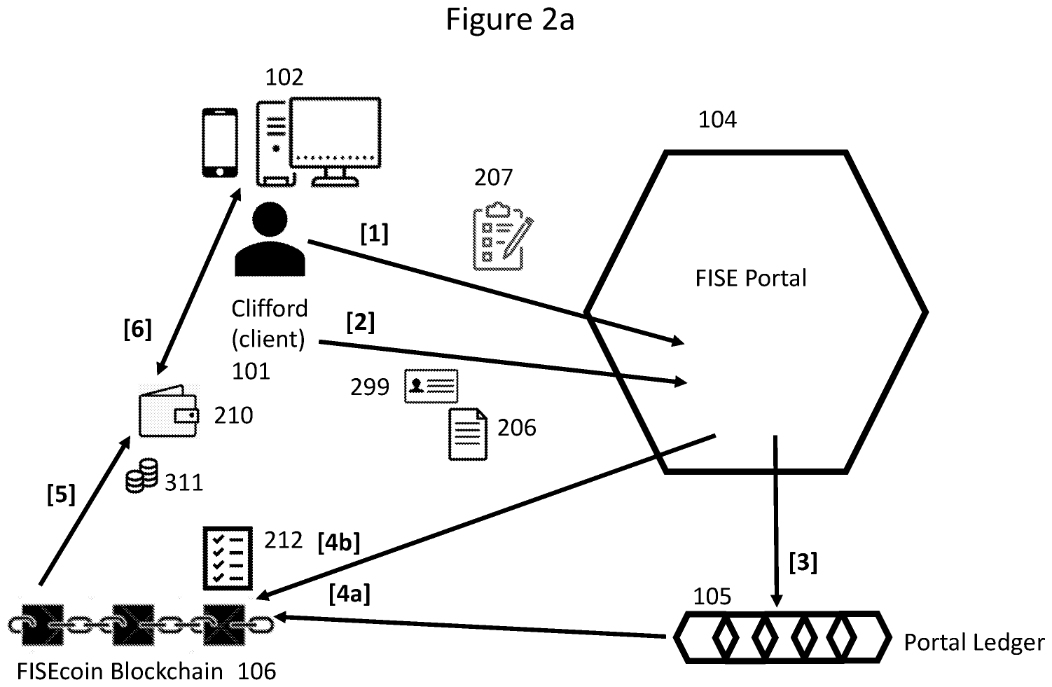

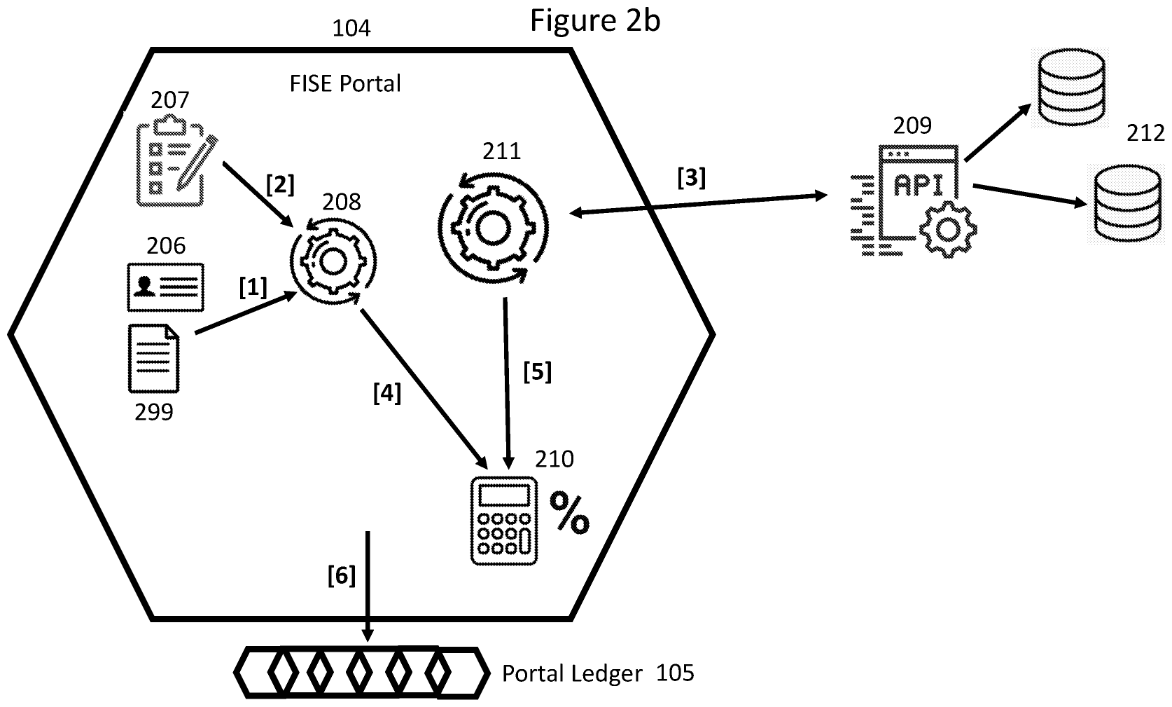

See FIG. 2.

It shows a user Clifford 101, who is a prospective bank customer, using his mobile device or computer 102, to connect to Global Bank Server 103 to apply for a bank account. This is designated by arrow [1].

When an entity or business needs to open an account, the authorized signer(s) connect to the Global Bank Server to apply for a business account. For simplicity, Clifford will represent an individual or an entity.

Once submitted, Brad 201, the banker, receives Clifford's application, designated by arrow [2].

Brad logs into FISE Portal 104, shown by arrow [3], inputs Clifford's email into the portal.

FISE Portal sends Clifford a FISE Portal web application link, shown by arrow [4]. For clarity, FIG. 2 shows one customer, Clifford. For the purpose of completing batch KYC, hundreds of emails may be inputted by the banker, either for new accounts or for remediating existing accounts.

Arrow [5] shows all KYC activities being recorded in FISE Portal's private ledger account for Global Bank. Arrows [6a] and [6b] show the confirmation of FISE Portal and FISE Portal's ledger fulfilling a smart contract 209 on FISEcoin Blockchain 106. The completion of the smart contract triggers the setup of a new wallet 210. FISEcoin tokens 211 are sent to the new wallet to incentivize Clifford for completing KYC.

The wallet and FISEcoin tokens become property of Clifford once registration and KYC are completed. Clifford may save, transfer, trade or cash out the FISEcoin tokens. Even if Clifford is denied a bank account, Clifford's wallet and FISEcoin tokens are his own. Clifford is now a participant of the token economy. With every FISEcoin transaction, Clifford's identity is known, thus reducing anonymity and increasing transparency within the token economy.

### 3. Gathering Customer Data and Documents

See FIG. 2a. Arrow [1] shows Clifford filling out his name, address, social security number, and date of birth in an online form 207. Arrow [2] shows him uploading official unexpired government issued photo ID 299, and a utility bill 206, to verify his physical address. If Clifford is an entity, more business incorporation documents, licenses and authorized signer documents are required, per federal guidelines.

Arrow [3] shows FISE Portal reporting Clifford's KYC activities to FISE Portal's private ledger 105 for Global Bank. Arrows [4a] and [4b] show FISE Portal and Ledger sending smart contract fulfillment data to FISEcoin Blockchain 106. This action triggers more FISEcoin tokens 311 to be sent to Clifford's wallet 210. The amount of FISEcoin tokens that are sent is determined by various criteria.

One criterion is the quantity of paperwork required of the customer. Another criterion occurs when Clifford submits expired documents. The smart contract may allow half the tokens to be sent due to the expired status. Once unexpired documents are uploaded, the smart contract allows for the other half of the tokens to be sent. The smart contract is coded to incentivize quantity of workload.

Therefore, if more documents are requested due to the type of entity, more tokens are escrowed for payment. Therefore, KYC for business accounts will generate more tokens due to the quantity of KYC paperwork and data required of the customer.

A third criterion occurs when the customer voluntarily answers additional questions about their professional and personal activities including social media links (e.g. Facebook Corp.), professional resume websites (e.g. LinkedIn Corp.), resulting in more FISEcoin token incentives.

A fourth criterion occurs when the customer voluntarily answers survey questions about their financial activities, resulting in more FISEcoin incentives.

### 4. Automated KYC Processing

See FIG. 2b. It shows the portal completing the following:
1. Process 208 extracts name, address, date of birth, identification number, ID expiration, etc from the uploaded images of the physical ID documents 206. Designated by arrow [1].
2. Process 208 matches the name and date of birth from form 207, which is designated by arrow [2], to the data found in 206. Process 208 also compares the ID expiration date to the current date. If the date is found to be past the current date, the customer is informed.
3. Process 208 saves the expiration date for future customer notifications to upload renewed photo ID before the ID expires.
4. Process 208 checks for a signature on Passport uploads.
5. Process 208 notifies customer of any missing information or discrepancies so that it may be remedied.
6. Process 211 connects to APIs 209 to validate name, social security number, and address, designated by arrow [3]. APIs 209 connect to external databases 212.
7. Process 210 calculates initial risk score percentile based on results from process 208 and process 211, as designated by arrows [4] and [5].
8. Arrow [6] shows Portal 104 reporting completed KYC activities to Portal Ledger 105 for record keeping.

### 5. Notification and Automated Due Diligence

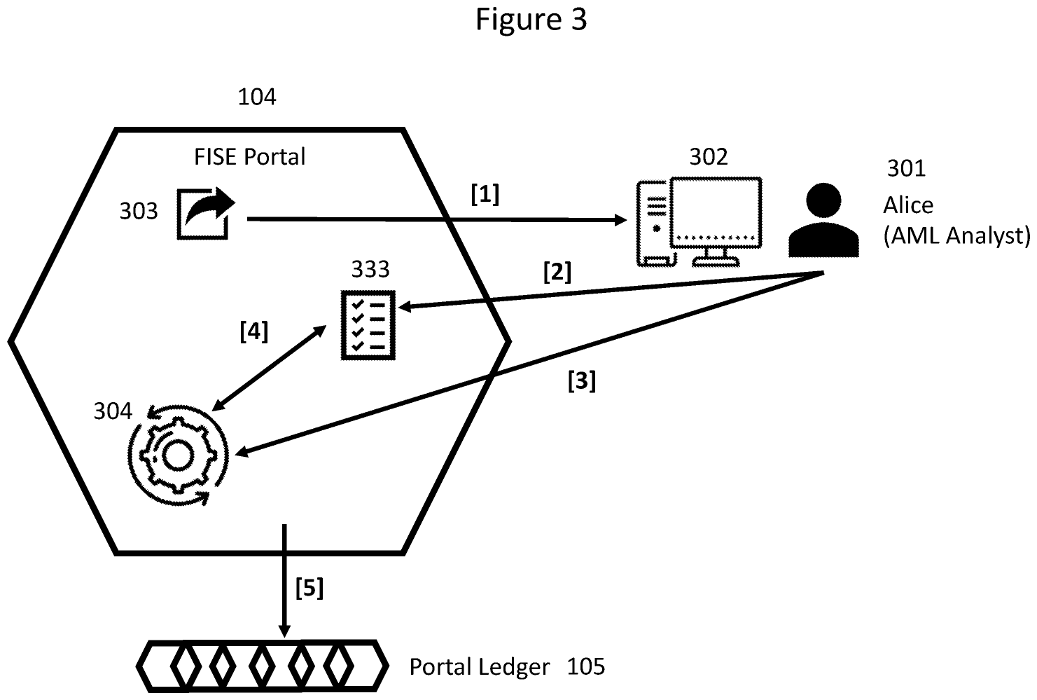

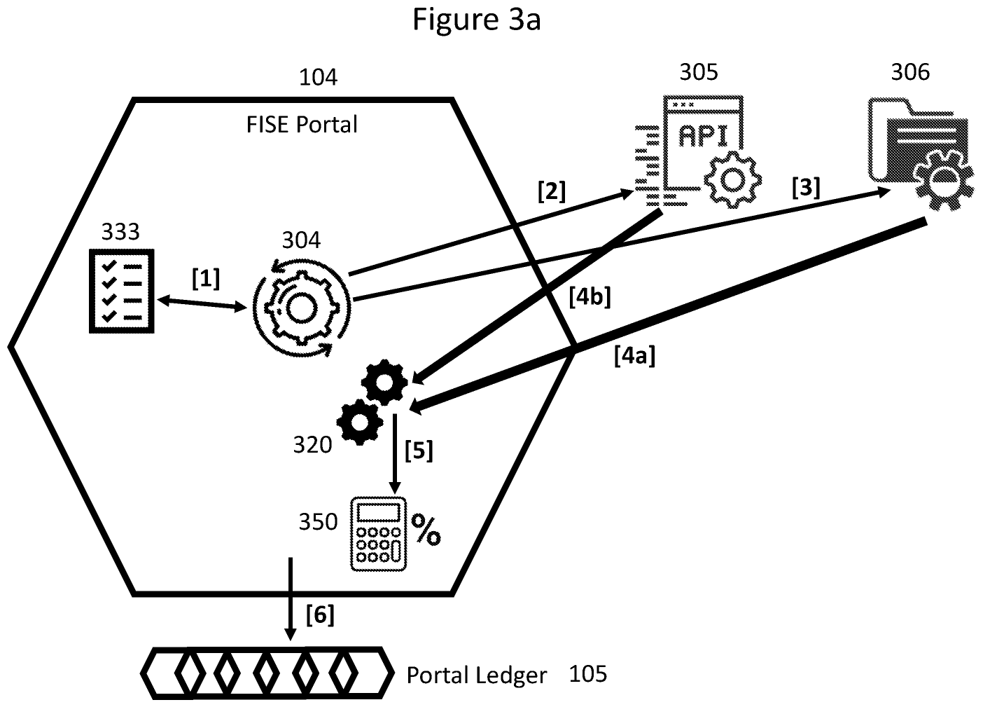

See FIG. 3.

Arrow [1] shows FISE Portal 104 sending notification 303, to Alice the AML Analyst 301, via her computer 302, that Clifford's fact checking results are complete.

Arrow [2] shows Alice logging in to view Clifford's application 333.

Arrow [3] shows Alice initializing FISE Portal to conduct automated due diligence on Clifford.

Arrow [4] shows the beginning of the process of due diligence which includes extracting, transforming, and loading customer identification information from Clifford's verified application 333.

See FIG. 3a.

Arrow [1] shows FISE Portal 104 extracting verified customer identification data 333.

Arrow [2] shows FISE Portal connecting to news APIs 305, with a customized search algorithm that returns news articles relating to money laundering, financial crimes, or related legal situations that are raw (potential) matches to Clifford. The customized search algorithm includes money laundering and financial crime terms and assigns a risk percentage value per article. The value could depend on how many key terms are found. Another risk value measures business risk based on the customer's history of legal disputes. This can include both when he/she is a defendant or plaintiff. The number of legal cases associated with the customer can also affect the risk value.

The average of all risk percentage values per term for each news article or legal case is calculated. This average assigns a risk percentage value to the article. Each article's average is calculated in the final average, which results in the money laundering risk percentage score.

Arrow [3] shows FISE Portal connecting to federal compliance lists 305 to search for Clifford's name. Arrows [4a] and [4b] show results from the news search and compliance lists being inputted into the risk percentage algorithm 320.

Arrow [5] shows algorithm 350 calculating the averages to produce a risk percentage value.

Arrow [6] shows FISE Portal 104 reporting all due diligence processes and results to Portal Ledger 105.

### 6. Summary and KYC Completion

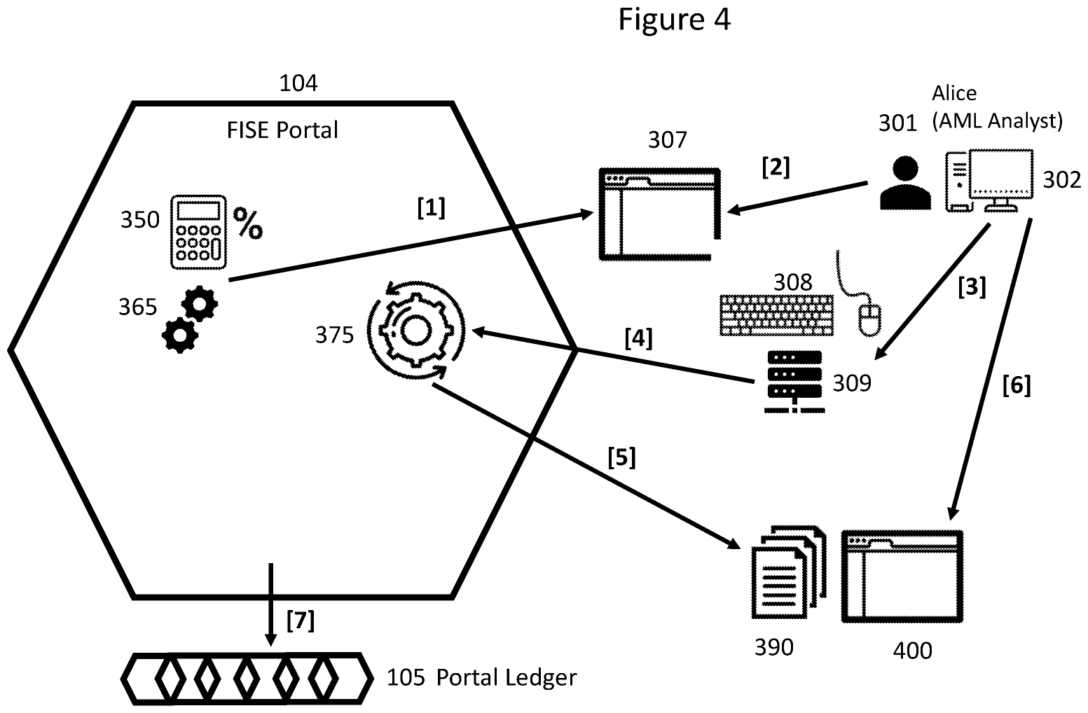

See FIG. 4.

Arrow [1] shows risk algorithm 350 and organizational processes 360, which presents the news articles and compliance list results on a browser page 307.

Arrow [2] shows Alice 301 viewing and analyzing the articles on her computer 302. The news articles have highlighted key words including name, location, age, and any money laundering related terms.

Arrow [3] shows Alice's interaction 308 with the Portal 104, which includes scanning the articles and confirming whether the article pertains to Clifford. If it is a positive match, Alice chooses true positive; if it is a negative match, Alice chooses false positive. Alice adds comments, to support her true or false positive conclusions. Alice's comments and choices are represented by 309.

Arrow [4] shows the Portal organizing FISE's data and Alice's final analyses, represented by 375.

Arrow [5] shows the creation of a summary document 390. It includes the Portal's results for fact checking, due diligence and Alice's final analyses/comments.

Arrow [6] shows Alice viewing the summary document in browser 400 on her computer 302. Other bank employees with proper permissions may also view it, without having to email or call Alice.

Arrow [7] shows FISE Portal reporting completed KYC steps to the Portal Ledger 105.

### 7. Portal Ledger Metrics

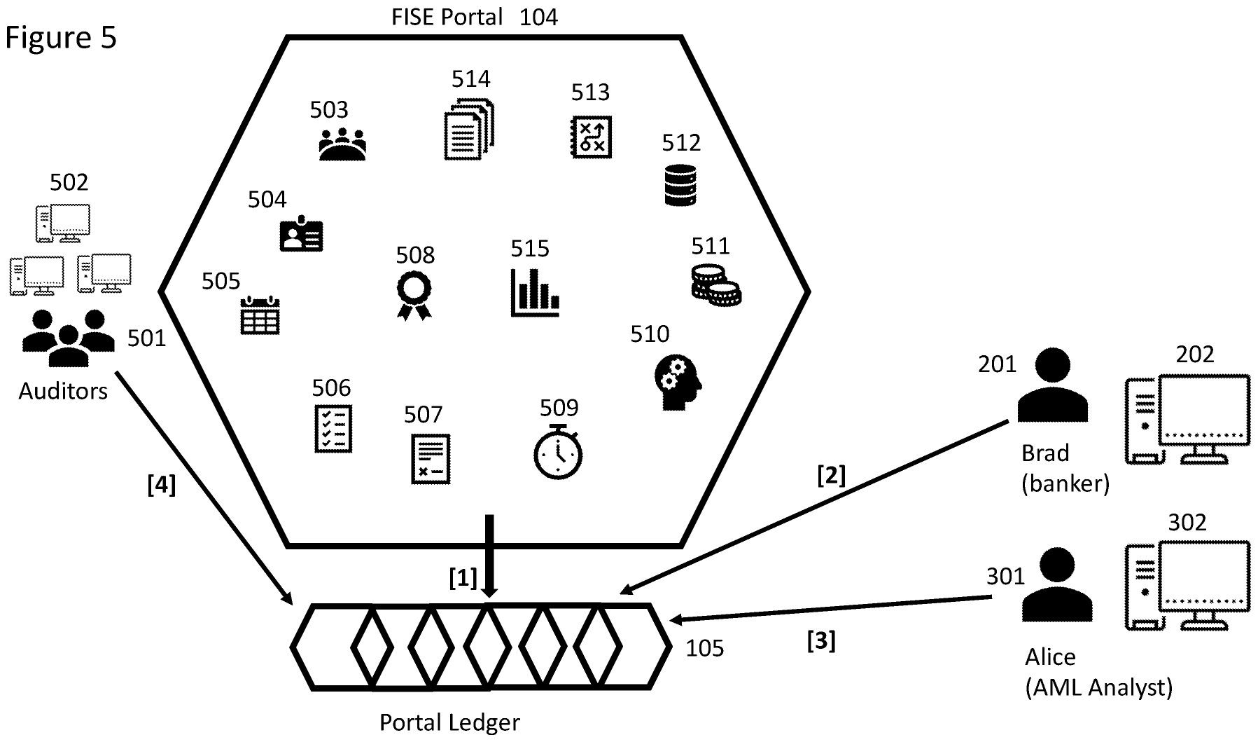

See FIG. 5.

Arrow [1] shows FISE Portal 104 sending records of completed KYC activities to Portal Ledger 105. The following records are kept:
Item 503: Names of employees completing KYC activity in FISE Portal.
Item 504: Identification documents uploaded, data extraction, and independent verification confirmation.
Item 505: Expiration dates extracted from Photo IDs, Business Licenses used to send auto notifications for customers to upload unexpired identification documents.
Item 506: KYC due diligence search for negative news results.
Item 510: AML Analyst decisions on true or false positives for each news articles, along with supporting commentary.
Item 507: Signed terms & conditions, agreements, and statements of accuracy for all users of FISE Portal.
Item 509: Time stamping for when each activity was completed.
Item 511: Incentive tracking and distribution for completed KYC due diligence cycles.
Item 512: Data storage location information. When a document is saved, this item reveals what folder or server it is saved in.
Item 513: Risk algorithm results with original data such as keywords from news articles and ID verification included.
Item 514: Summary document data.
Item 508: Employee KYC quiz and test scores.
Item 515: Employee metrics for KYC activity.

Arrow [2] shows Brad the banker 201, using his computer 202, to view the ledger. Brad is able to view his productivity metrics and look up KYC due diligence files for customers.

Arrow [3] shows Alice the AML Analyst 301, using her computer 302, to view the ledger. Alice is able to view her productivity metrics and look up KYC due diligence files for customers. Permissions for each employee for what they can view in the ledger are adjustable, depending on rank and authorization.

Arrow [4] shows auditors 501, using their computers 502, to view the ledger. Auditors are able to view KYC due diligence processes for each customer, time stamps, ID verification documents, signed statements, and all relevant information that supports the audit.

### 8. Incentivization

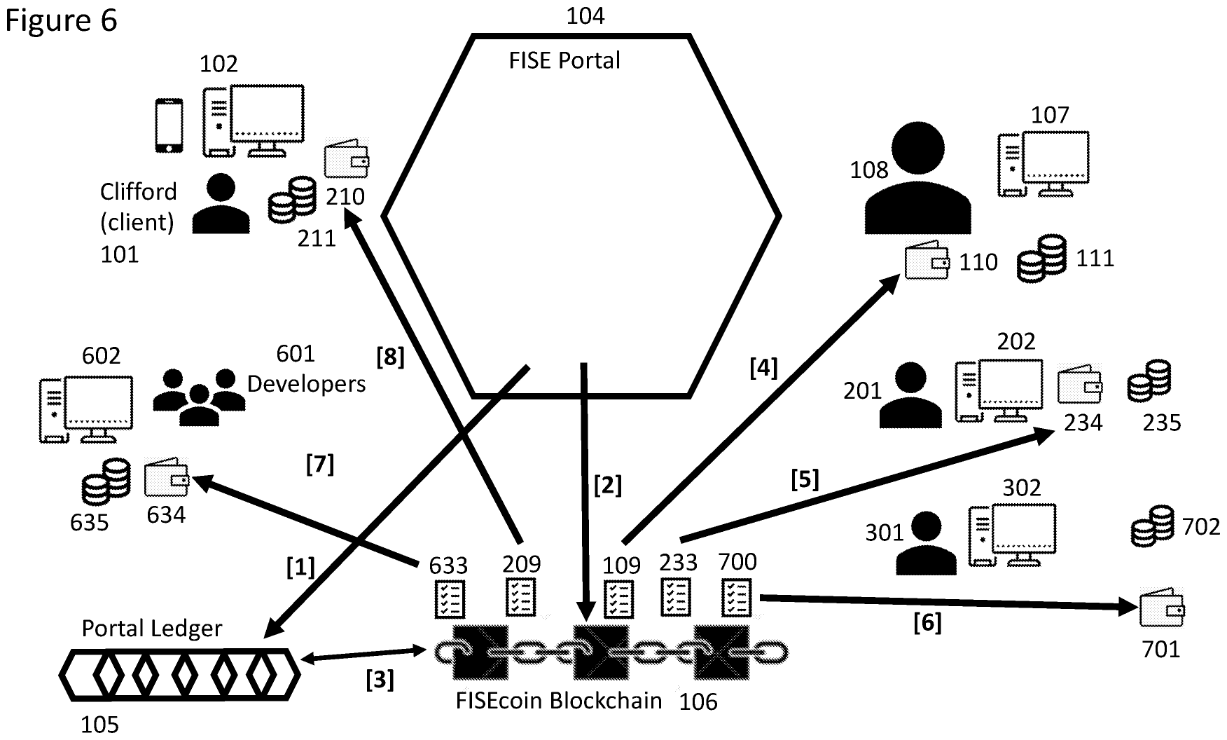

See FIG. 6.

When a user is registered with FISE Portal 104, it reports this to the Portal Ledger 105 and the FISEcoin Blockchain 106. A wallet with encoded smart contracts specific to the user is created. In FIG. 6, the following smart contracts and wallets for each user are shown:
1. Developer smart contract 633
2. Developer wallets 634
3. Customer's smart contract 209
4. Customer's wallet 210
5. Subscribing Financial Institution smart contract 109
6. Subscribing Financial Institution wallet 110
7. Banker's smart contract 233
8. Banker's wallet 234
9. AML Analyst smart contract 700
10. AML Analyst wallet 701

Once a user completes the fulfillment requirements of the smart contracts encoded in the wallet, the user is compensated with FISEcoin.

Arrow [1] shows FISE Portal 104 reporting all KYC activities to Portal Ledger 105.

Arrow [2] shows FISE Portal reporting all KYC activities to FISEcoin Blockchain, fulfilling smart contracts and triggering payments.

Arrow [3] shows Portal Ledger confirming the activities with FISEcoin blockchain. This action serves as additional validation support and evidence for the fulfillment of smart contracts, payments, and auditing of these functions. Arrow [3] represents the bilateral communication between FISEcoin blockchain and FISE Portal Ledger.

Arrow [4] shows the payment of FISEcoin 111 sent to the wallet of the subscribing financial institution, Global Bank 110. One function of the smart contract for a subscribing institution includes loss of customer compensation. For example, if Global Bank must terminate customers due to high money laundering risks, Global Bank is compensated with FISEcoin for the loss of business, up to nine months in advance of what Global Bank would have profited through the terminated account(s).

Arrow [5] shows payment of FISEcoin 235 sent to the wallet of Brad the banker 234 for completing KYC activities. One function of the smart contract includes compensation for loss of a customer. For example, if one of Brad's clients must be terminated due to high money laundering risks, Brad is compensated with FISEcoin for the loss of commissions, up to nine months in advance of what he would have earned through the terminated account.

Arrow [6] shows payment of FISEcoin 702, sent to the wallet of Alice the AML Analyst 701 for initializing due diligence, analyzing news articles, finalizing true and false positives, writing supporting commentary, and finalizing the KYC risk classification process.

Arrow [7] shows payment of FISEcoin 635, sent to Developers' wallets 634 for fixing bugs, upgrading software, and reinforcing security.

Arrow [8] shows payment of FISEcoin 211 sent to the wallet of Clifford the client 210, for registering with FISE Portal, uploading identification documents, and complying with KYC procedure.

We claim:

1. A method of a server performing administrative functions of gathering, comparing, and analyzing data to calculate an initial risk score; where the server extracts data from identification documents and matches the extracted data to customer inputted data; the server connects to fact checking databases to confirm customer identification.

2. The method of claim 1, where the server searches an uploaded passport of a customer for a signature; where the server requests a signature from the customer if none is found.

3. The method of claim 1, where the server captures and saves an expiration date from a photo ID or business license of a customer; where the server schedules future notification to the customer to upload a new photo ID or business license.

4. The method of claim 1, where the server connects to a news source; where the server uses a customized algorithm to search the news source for negative news about a customer; where the server highlights all keywords in articles related to the algorithm; where the server assigns a value to each word and calculates a risk percentage from the assigned values.

5. The method of claim 1, where the server creates a summary document with the customer data, identification fact checking results, uploaded documents, negative news articles, and risk score; where the server communicates with a ledger, writing data to the ledger.

6. The method of claim 1, where the server sends user data to a blockchain; where the server determines user type and sends a user-specific smart contract to the blockchain; where the server creates a wallet for the user upon registration; where the server sends completion of tasks of the user to the blockchain for smart contract fulfillment and token payment to the wallet of the user.

7. The method of claim 6 where a user type includes customer, banker, analyst, employee, developer, auditor, or subscribing institution.

8. The method of claim 6 where the server receives a communication from the blockchain; where the server receives a communication from the ledger; where the server reconciles token payments and tasks; where the server audits tasks and smart contract fulfillment payments.
